(19) United States
(12) Patent Application Publication
(10) Pub. No.: US 2012/0048889 A1
(43) Pub. Date: Mar. 1, 2012

(54) Pusher Unit of Glue Applicator

(76) Inventor: Huang Yung-Kuan, Shuishang Township (TW)

(21) Appl. No.: 12/868,795

(22) Filed: Aug. 26, 2010

(51) Int. Cl. B05C 17/01; B67D 7/80; B65H 20/00

(52) U.S. Cl. 222/146.5; 226/127

(57) ABSTRACT

An improvement to a feeding unit of a glue applicator is disclosed. The glue applicator includes a body having a heat chamber and a feeding unit for pushing a glue stick into the heat chamber. The feeding unit includes a sliding seat sliding in the body and allowing the glue stick to pass therethrough. A gripper pivotally fixed to the sliding seat is rotatable to engage with the glue stick, and has a projecting portion extending slantwise downward. A trigger pivotally fixed to the body automatically returns to an initial position thereof, and has a top thereof provided with a recess for receiving the projecting portion of the gripper. When the trigger is transversely drawn toward the body, the recess pushes the gripper to engage the glue stick, so the glue stick is advanced together with the sliding seat, causing the glue stick to be fed into the heat chamber.

### FIELD OF THE INVENTION

The present invention relates to a mechanical improvement made to a feeding unit of a glue applicator. More particularly, the present invention provides a feeding unit for drawing and thus feeding a glue stick installed therein. The feeding unit is composed of reduced number of components and allows a more effort-saving operation.

### BACKGROUND OF THE INVENTION

As generally known, a glue applicator is used to heat a glue stick and to apply the melted glue for adhesion. Such a glue applicator is typically designed with a gun-like shape. However, the gun-like glue applicator is less controllable for accurate placement of the glue. Therefore, a glue applicator featuring for being easily held has been developed, as disclosed in U.S. Pat. No. 6,820,768.The patented glue applicator primarily has a body, a cavity extending along the longitudinal axis of the body, a heat chamber received in and extending parallel to the cavity so as to receive a glue stick placing therein, and a feeding unit with a trigger The trigger member is configured to push the glue stick into the heat chamber, while its outer side to be gripped by a user's palm performs transverse motion.

Thereby, the user can hold the glue applicator in his/her palm with his/her fingers holding the trigger, and make a nozzle of the glue applicator face the user or the user can hold the glue applicator vertically, thus allowing an easier and more accurate glue-placing operation.

However, the mechanisms for controlling and feeding the glue stick include, in addition to the trigger, a gripping mechanism with a gripper, and the trigger has an arm, wherein the a link is provided between the arm and the gripper, so that the arm is driven to swing forward by the trigged trigger, and then the link drives the gripper to grip the glue stick, thereby making the gripping mechanism together with the glue stick advance into the heat chamber. Thus, this is not a case where the trigger drives the gripping mechanism directly, whereas the link is required to achieve the movement.

Since the entire structure involves a relatively large number of complex components, assembly of the existing glue applicator is difficult and inconvenient, which significantly affects the efficiency and costs of production. In addition, feeding the glue stick relies on the link, but is not accomplished by the trigger directly. When there are more fastening components required, there are more joints, suggesting a higher risk of misplay and failure, as well as a more laborious operation. Consequently, in a glue-placing application where high preciseness is required, the laborious operation may lead to failure in placing the glue accurately.

### SUMMARY OF THE INVENTION

With the attempt to solve the problems of the known glue applicators whose feeding means are structurally complex and operatively unsmooth and tend to fail and require laborious operation, the present invention provides a feeding unit that has relatively simple structure composed of a reduced number of components, while allowing a more reliable and effort-saving operation.

Therefore, the technical means, upon which the present invention relies to solve the problems of the prior art, is to have a glue applicator including a body receiving therein a heat chamber extending axially, and the feeding unit drawing a glue stick into the heat chamber, wherein the feeding unit comprises a sliding seat configured to slide along a direction in which the glue stick is fed, pivotally fixed with a gripper, and configured to allow the glue stick to pass therethrough, while the gripper has its lower end provided with a projecting portion for abutting against a trigger that is pivotally fixed to the body and is provided with a recess corresponding to the projecting portion.

In addition, the sliding seat of the present invention is bilaterally provided with wing portions for sliding in and along sliding guides formed on the body.

Moreover, the gripper of the present invention has its top surface formed as a toothed anti-slip engaging surface, and has its front end provided with a notch fitting the sliding seat, while having a holding portion for holding a spring between the gripper and a rear end of the body.

Furthermore, the trigger of the present invention has its upper front end provided with an abutting portion, and has its outer side provided with a pressing portion for a user to hold with his/her fingers.

Thereby, the feeding unit of the present invention is composed of merely the sliding seat, the gripper and the trigger, so it is simpler in structure, easy to assemble, and more effective to produce. Meanwhile, sliding of the sliding seat is driven by the trigger directly, so the operation is more effort-saving and the entire glue applicator is easier to grip, thereby ensuring accurate glue placement for more precise adhesive application.

### BRIEF DESCRIPTION OF THE DRAWINGS

FIG. 1 is an exploded view of the present invention.

FIG. 2 is a lateral cross-sectional view of the present invention.

FIG. 3 is a schematic drawing according to the present invention showing a trigger trigged.

FIG. 4 is a schematic drawing according to the present invention showing the trigger released.

### DETAILED DESCRIPTION OF THE INVENTION

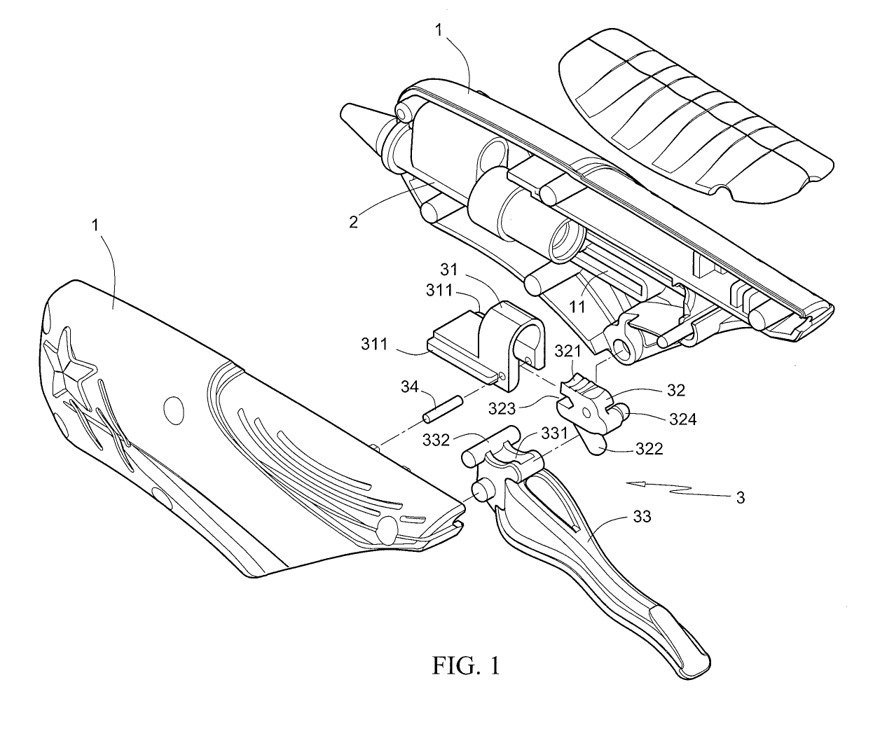

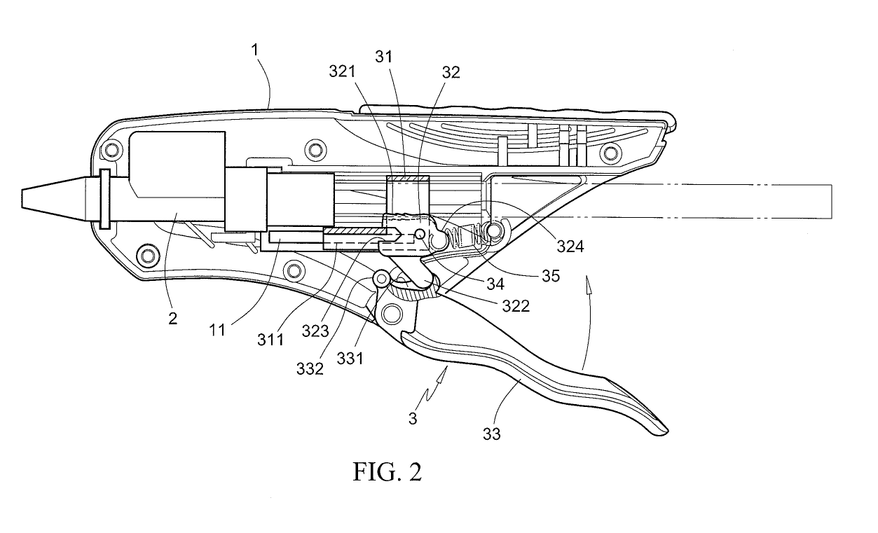

Please refer to FIGS. 1 and 2. The present invention is directed to a glue applicator that comprises a body 1 receiving a heat chamber 2 at a front end thereof, and a feeding unit 3 for driving a glue stick into the heat chamber 2. The feeding unit 3 further includes a sliding seat 31 that allows the glue stick to pass therethrough and is bilaterally provided with wing portions 311, so that the wing portions 311 are configured to slide along sliding guides 11 provided on the body 1. At a lower rear portion of the sliding seat 31, a pivotal shaft 34 positions a swingable gripper 32. The gripper 32 has its front end provided with a notch 323 fitting the sliding seat 31, with its top surface provided with a toothed anti-slip engaging surface 321, with its lower end provided with a projecting portion 322 extending slantwise downward, and with its one lateral provided with a holding portion 324.

Moreover, the feeding unit 3 further comprises a trigger 33 pivotally fixed to the body 1 and located below the gripper 32. The trigger 33 has its top surface provided with a recess 331 for receiving the projecting portion 322 of the gripper 32, with its upper front end provided with an abutting portion 332, and with its outer side provided with a pressing portion for a user to hold with his/her fingers.

Furthermore, a spring 35 is connected between the holding portion 324 of the gripper 32 and the body 1, so that the resilience of the spring 35 makes the sliding seat 31 to move backward automatically and in turn drive the trigger 33 to return to its initial, released position.

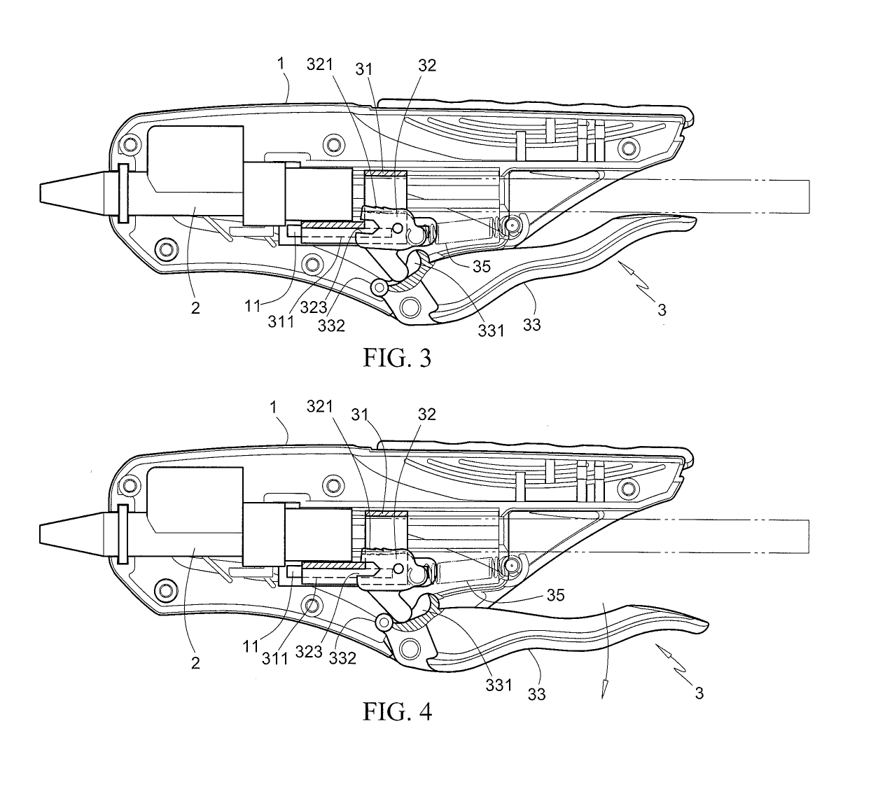

Referring to FIG. 3, when the user holds the body 1 with his/her palm, and uses his/her fingers to tightly press the pressing portion at the outer side of the trigger 33 transversely toward the body 1, the recess 331 of the trigger 33 pushes the projecting portion 322 of the gripper 32, and meantime makes the gripper 32 to rotate to have its engaging surface 321 abutting against the glue stick, so the glue stick together with the sliding seat 31 is drawn forward and the glue stick is finally pushed into the heat chamber 2. On the contrary, as shown in FIG. 4, when the user relax his/her fingers, the spring 35 pulls the gripper 32 together with the sliding seat 31 backward, and meantime makes the gripper 32 rotate oppositely to disengaged the engaging surface 321 from the glue stick while the moving back projecting portion 322 of the gripper 32 also makes the trigger 33 to automatically expand and return to its initial, released position.

Hence, since the foregoing feeding unit 3 is only composed of the sliding seat 31, the gripper 32 and the trigger 33, it involves a reduced number of components and a simplified structure, meaning that the glue applicator is easier to assemble and that interactions between the components are more reliable. In addition, in virtue that the trigger 33 directly drives the gripper 32 and the sliding seat 31 to engage with each other and move, feeding the glue stick is more effort-saving, thereby ensuring more accurate glue placement for more precise adhesive application.

What is claimed is:

1. An improvement to a feeding unit of a glue applicator, which includes a body receiving therein an axially extending heat chamber, and a feeding unit for pushing a glue stick into the heat chamber, the feeding unit comprising:
a sliding seat being configured to slide axially in the body and allow the glue stick to pass therethrough;
a gripper being pivotally fixed to the sliding seat, being configured to rotate to have a top surface thereof engaging with the glue stick, and having a lower end provided with a projecting portion extending slantwise downward; and
a trigger being pivotally fixed to the body, being configured to automatically return to an initial position thereof, and having a top thereof provided with a recess for receiving the projecting portion of the gripper.

2. The improvement to the feeding unit of the glue applicator according to claim 1, wherein the sliding seat is bilaterally provided with wing portions, and the body is provided with sliding guides for allowing the wing portions to slide therein.

3. The improvement to the feeding unit of the glue applicator according to claim 1, wherein the gripper has the top surface formed as a toothed anti-slip engaging surface.

4. The improvement to the feeding unit of the glue applicator according to claim 1, wherein the trigger has an upper front end provided with an abutting portion, and has an outer side provided with a pressing portion for a user to hold with his/her fingers.

5. The improvement to the feeding unit of the glue applicator according to claim 1, wherein a spring is connected between one side of the gripper and a rear end of the body.

6. The improvement to the feeding unit of the glue applicator according to claim 1, wherein the gripper has a front end provided with a notch, which fits the sliding seat.

7. The improvement to the feeding unit of the glue applicator according to claim 1, wherein the gripper has one side provided with a holding portion, so that a spring is allowed to is connected between the holding portion and a rear end of the body.
